(19) United States
(12) Patent Application Publication
(10) Pub. No.: US 2004/0164790 A1
(43) Pub. Date: Aug. 26, 2004

(54) Bias circuit having a start-up circuit

(75) Inventors: Jae-jun Moon, Seoul (KR); Jeong-won Lee, Sungnam-city (KR); Jung-eun Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/777,097

(22) Filed: Feb. 13, 2004

(30) Foreign Application Priority Data
Feb. 24, 2003 (KR) 2003-11400

(51) Int. Cl. G05F 3/02

(52) U.S. Cl. 327/546

(57) ABSTRACT

Disclosed is a bias circuit having a start-up circuit. The bias circuit having a start-up circuit has a bias circuit part using a current mirror circuit, and for generating a constant bias voltage to an output node from an application of a power source voltage, and a start-up circuit part having a capacitor connected between the output node and a common node of in common connecting gates of MOS transistors constructing the current mirror circuit. Accordingly, the bias circuit prevents noise delivered from a power source voltage and power consumption due to static currents, and eliminates the oscillation possibility with stability improved in a high frequency range.

### BACKGROUND OF THE INVENTION

1. Field of the Invention

The present invention relates to a bias circuit having a start-up circuit, and more particularly, to a bias circuit having a start-up circuit, which prevents noise from power source voltage and power consumption due to static currents and is improved in a high frequency range stability. The present application is based on Korean Patent Application No. 2003-11400, which is incorporated herein by reference.

2. Description of the Related Art

In general, various kinds of bias circuits are used upon designing analog circuits, and a start-up circuit is used in such bias circuits in order to prevent transient states occurring at the beginning of a supply of power source voltage. That is, the start-up circuit refers to a circuit that operates only at the beginning of power supply so that a bias circuit generates a stable bias voltage.

FIG. 1 is a view for showing a general bias circuit using the Wilson current mirror. Referring to FIG. 1, a bias circuit has PMOS transistors MP₁₁ and MP₁₂, NMOS transistors MP₁₃ and MP₁₄, and a resistor R₁₁.

The bias circuit structured as above has two operation states. One of the two operation states is to output a normal bias voltage, and the other state is to perform abnormal operations at the initial time that a power source voltage is applied. That is, when the power source voltage is applied, a node N₁₁ at which the gates of the PMOS transistors MP₁₁ and MP₁₂ are connected has a predetermined power source voltage value, and a node N₁₂ has a voltage of “0”. The voltage of the node N₁₂ is amplified by a predetermined voltage applied through the PMOS transistor MP₁₁. Accordingly, the PMOS transistors MP₁₁ and MP₁₂ constructing the current mirror maintain a turn-on state due to the voltage of the node N₁₁, and, at this time, if the PMOS transistors MP₁₁ and MP₁₂ have the same W/L ratio, the same current is applied to NMOS transistors MN₁₃ and MN₁₄. A voltage of the node N₁₂ applied through the PMOS transistors turns on the NMOS transistors MN₁₃ and MN₁₄. In here, if the NMOS transistors MN₁₃ and MN₁₄ have the same W/L ratio, a current flowing in a resistor R₁₁ becomes identical to a current flowing in the NMOS transistor MN₁₃. Through such operations, a normal bias voltage V_{REF} is output through a REF terminal.

However, if the nodes N₁₁ and N₁₂ have fixed voltages at the initial time that a power source voltage is applied, the NMOS transistors MN₁₃ and MN₁₄ are turned off to cut off the current flow, which prevents normal voltages from being produced. Accordingly, the start-up circuit is needed to prevent transient states occurring at the beginning of a supply of power source voltage.

FIG. 2 to FIG. 4 are views for showing bias circuits having conventional start-up circuits.

In FIG. 2, to a bias circuit of FIG. 1 is added a start-up circuit 20 consisting of a resistor R₁₂ and a capacitor C₂₁.

In such a circuit configuration, if a node N₂₁ is supplied with a voltage enough to turn on an NMOS transistor MN₂₃ through a resistor R₂₂ and a capacitor C₂₁ at the initial state that a power source voltage is supplied, PMOS transistors MP₂₁ and MP₂₃ and the NMOS transistor MN₂₄ are turned on, so that a bias voltage V_{REF} is outputted through an REF terminal. Since the capacitor C₂₁ cuts off current flows at the stable state of power source voltage, there exists no loss caused due to static currents.

However, such a circuit has a drawback in that noise existing on a power source voltage and the like is coupled with the bias voltage V_{REF} through the resistor R₂₂ and the capacitor C₂₁ and thus affect the bias voltage V_{REF}.

FIG. 3 is a view for showing another example of a bias circuit having a conventional start-up circuit. In FIG. 3, a start-up circuit 30 is used in which diode-connected PMOS transistors MPP₀˜MPPₙ are connected in multiple stages.

In such a circuit configuration, the diode-connected PMOS transistors MPP₀˜MPPₙ of multiple stages remain in the turn-on state all the time. Therefore, a voltage of a node N₃₁ is expressed in Equation 1 as follows:

V_{N31}=V_{CC}−2V_{TH} [Equation 1]

wherein V_{TH} denotes a threshold voltage of a MOS transistor.

Since a voltage of the node N₃₁ becomes a gate voltage of a PMOS transistor MP₃₃, a source voltage of the PMOS transistor MP₃₃, that is, a voltage of a node N₃₂ satisfies following Equation 2 with the increase of the power source voltage so that the PMOS transistor MP₃₃ is turned on.

V_{N32}>V_{CC}−V_{TH} [Equation 2]

Therefore, a PMOS transistor MP₃₁ and NMOS transistors MN₃₃ and MN₃₄ are all turned on so that the bias circuit operates its functions in the normal state. At this time, a voltage of a node N₃₂ starts falling down since an NMOS transistor MN₃₄ is in turn-on state, which turns off the PMOS transistor MP₃₃ so that the start-up circuit completes its function, dissatisfying Equation 2.

However, such a circuit configuration has a drawback in that power loss occurs since static currents exist all the time through the PMOS transistors MPP₀˜MPPₙ in multiple stages.

FIG. 4 is a view for showing still another example of a bias circuit having a conventional start-up circuit. In FIG. 4, a start-up circuit 40 has the gate of an NMOS transistor MNN₀ connected in common to the gates of two PMOS transistors MP₄₁ and MP₄₂ of the bias circuit. Accordingly, as power is turned on, a voltage of a node N₄₁ increases with a supply of the power source voltage. Since an REF terminal has an initial voltage of “0”, an NMOS transistor MNN₀ is turned on according to Equation 3 as follows:

V_{N41}−V_{REF}>(n+1)V_{TH} [Equation 3]

At this time, all transistors MPP₀ and MNN₁˜MNNₙ connected in series in the start-up circuit 40 are turned on so that the voltage of a terminal REF, V_{REF}, increases. The increased voltage V_{REF} turns on the NMOS transistors MN₄₃ and MN₄₄. Accordingly, the bias circuit enters its normal operation state. Therefore, a difference between the voltage of the N₄₁ and the voltage V_{REF} decreases, so the NMOS transistor MNN₀ is turned off according to Equation 4 as follows:

V_{N41}−V_{REF}<(n+1)V_{TH} [Equation 4]

Such a circuit configuration performs a function of cutting off static current consumption in the start-up circuit, to thereby reduce power loss, playing a role of suppressing noise from the power source voltage.

However, such a circuit has a structure of connecting two amplifiers in the positive feedback manner, that is, an amplifier of PMOS transistor MP₄₁ loading the NMOS transistor MN₄₃, and the other amplifier of NMOS transistor MN₄₄ loading the PMOS transistor MP₄₂. An amplification gain of such a feedback loop has a small value in a low frequency range, but can have a large value in a high frequency range due to a load capacitor and the like. Accordingly, the circuit can have a gain value larger than 0 dB in a high frequency range, which causes a frequency stability problem of oscillating an output. Such a problem occurs even in the circuits of FIG. 2 and FIG. 3 alike.

FIG. 5A and FIG. 5B are views for showing frequency characteristics of bias circuits having conventional start-up circuits. In FIGS. 5A and 5B, if the gain becomes larger than 0 dB in a high frequency range, a phase margin becomes nearly close to 0 or negative (−) at the point that the gain becomes 0 dB, but the gain becomes smaller as a load becomes larger.

FIG. 6 is a view for showing the measurements of an output voltage of a bias circuit having a conventional start-up circuit. In FIG. 6, the oscillation of the output voltage can be seen.

Accordingly, as can be seen in FIG. 5A, FIG. 5B, and FIG. 6, the bias circuits having the conventional start-up circuits need to be reviewed in the aspect of stability, and solutions are needed for the stability problems.

### SUMMARY OF THE INVENTION

The present invention has been devised to solve the above problems, so it is an aspect of the present invention to provide bias circuits having a start-up circuit which eliminate noise from a power source voltage and power consumption due to static currents and improve stability characteristics in a high frequency range.

In order to achieve the above aspect, a bias circuit having a start-up circuit comprises a bias circuit part using a current mirror circuit, and for generating a constant bias voltage to an output node from an application of a power source voltage, and a start-up circuit part having a capacitor connected between the output node and a common node of in common connecting gates. of MOS transistors constructing the current mirror circuit.

The bias circuit part includes a first PMOS transistor having the source thereof connected to the power source voltage; a second PMOS transistor having the gate and drain thereof connected to the gate of the first PMOS transistor to form the common node, and having the source thereof connected to the power source voltage; a first NMOS transistor having the drain and gate thereof connected to the first PMOS transistor to form the output node, and having the source thereof connected to the power source voltage; a second NMOS transistor having the drain thereof connected to the drain of the second PMOS transistor, and having the gate thereof connected to the gate of the first NMOS transistor; and a resistor connected the source of the second NMOS transistor and the ground.

Further, in order to achieve the above object, a bias circuit having a start-up circuit comprises a bias circuit part using the cascode current mirror circuit of a double-stage current mirror circuit, and for generating a constant bias voltage to an output node from an application of a power source voltage; and a start-up circuit part for actuating the bias circuit part upon an initial application of the power source voltage, the start-up circuit part including a first capacitor connected between a first common node connecting in common the gates of MOS transistors constructing a single-stage current mirror circuit of the cascode current mirror circuit and a second common node connecting in common the gates of MOS transistors constructing the other single-stage current mirror circuit; and a second capacitor connected between the second common node and the output node.

The bias circuit part includes a first PMOS transistor having the gate connected to the power source voltage; a second PMOS transistor having the gate and drain thereof connected to the gate of the first PMOS transistor to form the first common node, and having the source thereof connected to the power source voltage; a third PMOS transistor having the source thereof connected to the drain of the first PMOS transistor; a fourth PMOS transistor having the gate and drain thereof connected to the gate of the first PMOS transistor to form a second common node, and having the source thereof connected to the drain of the second PMOS transistor; a first NMOS transistor having the drain and gate thereof connected to the drain of the third PMOS transistor to form the output node, and having the source thereof connected to the power source voltage; a second NMOS transistor having the drain thereof connected to the drain of the fourth PMOS transistor, and having the gate thereof connected to the gate of the first NMOS transistor; and a resistor connected between the source of the second NMOS transistor and the power source voltage.

### BRIEF DESCRIPTION OF THE DRAWINGS

The invention will be described in detail with reference to the following drawings in which like reference numerals refer to like elements, and wherein:

FIG. 1 is a view for showing a general bias circuit having the Wilson current mirror;

FIG. 2 to FIG. 4 are views for showing bias circuits having conventional start-up circuits;

FIG. 5A and FIG. 5B are views for showing frequency characteristics of a bias circuit having a conventional start-up circuit;

FIG. 6 is a view for showing a waveform of an output voltage of a bias circuit having a conventional start-up circuit;

FIG. 7 is a view for showing a bias circuit having a start-up circuit according to a first embodiment of the present invention;

FIG. 8 is a view for showing an equivalent circuit of FIG. 7;

FIG. 9 is a view for showing frequency characteristics of a bias circuit having a start-up circuit according to a first embodiment of the present invention;

FIG. 10A to FIG. 10C are views for showing waveforms of bias circuits having conventional start-up circuits and start-up circuits according to an illustrative embodiment of the present invention;

FIG. 11 is a view for showing waveforms of output voltages of bias circuits having conventional start-up circuits and start-up circuits according to an illustrative embodiment of the present invention;

FIG. 12 is a view for showing a bias circuit having a start-up circuit according to a second embodiment of the present invention;

FIG. 13 is a view for showing a bias circuit having a start-up circuit according to a third embodiment of the present invention; and

FIG. 14 is a view for showing a bias circuit having a start-up circuit according to a fourth embodiment of the present invention.

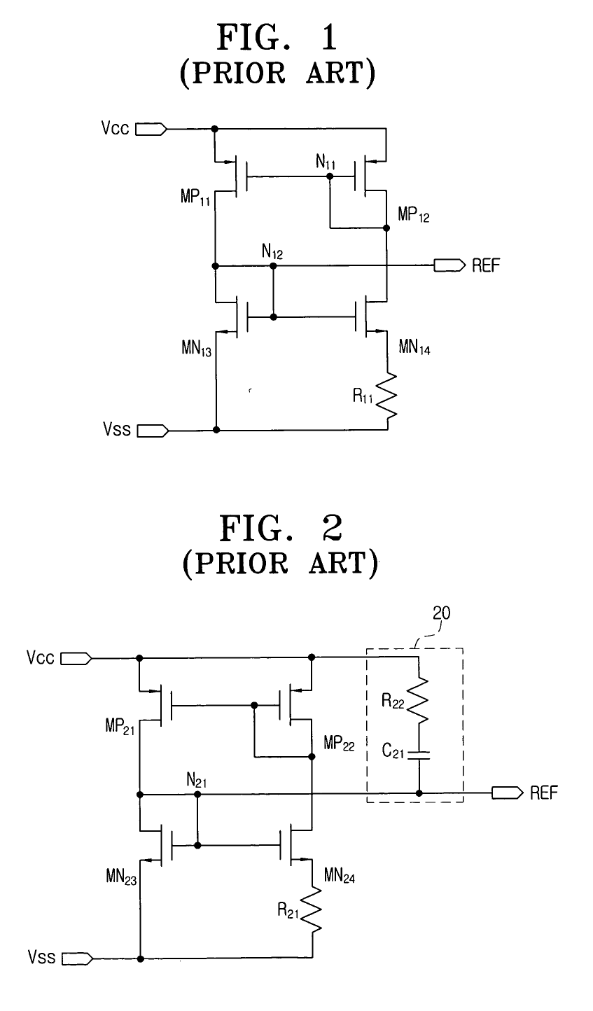

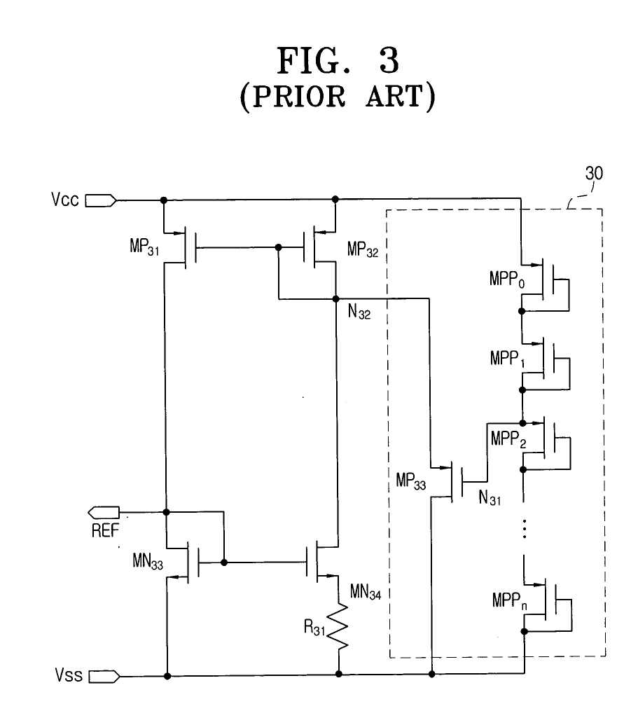

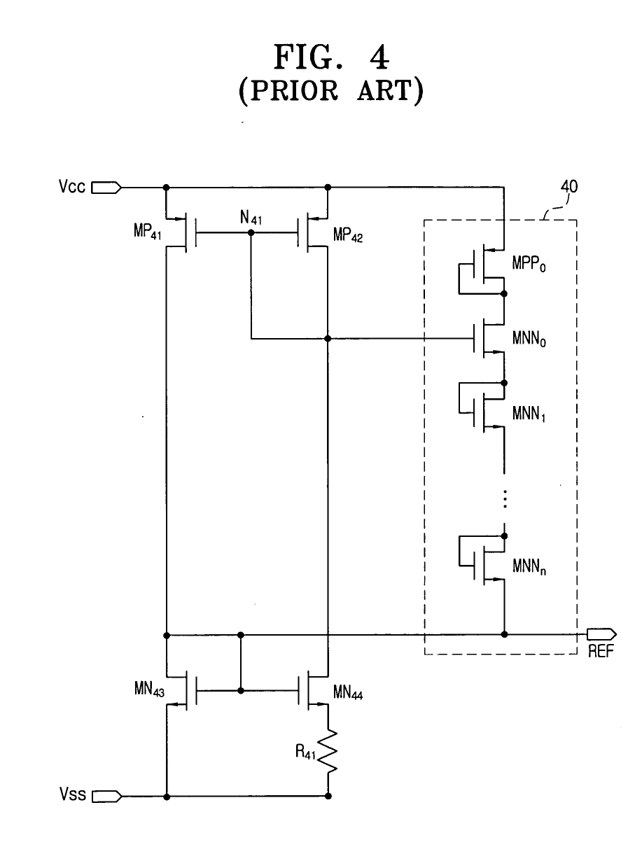

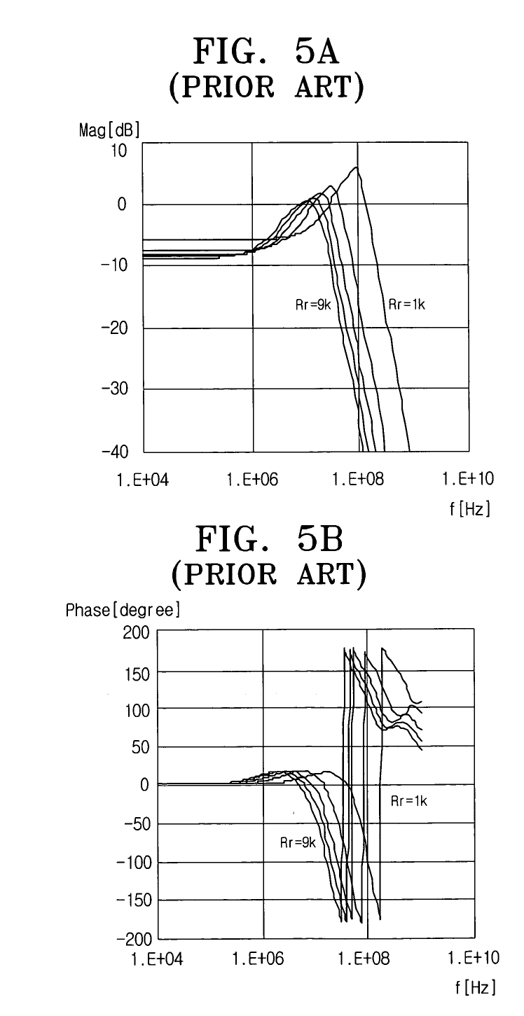

### DETAILED DESCRIPTION OF THE PREFERRED EMBODIMENTS

Hereinafter, the present invention will be described in detail with reference to the drawings.

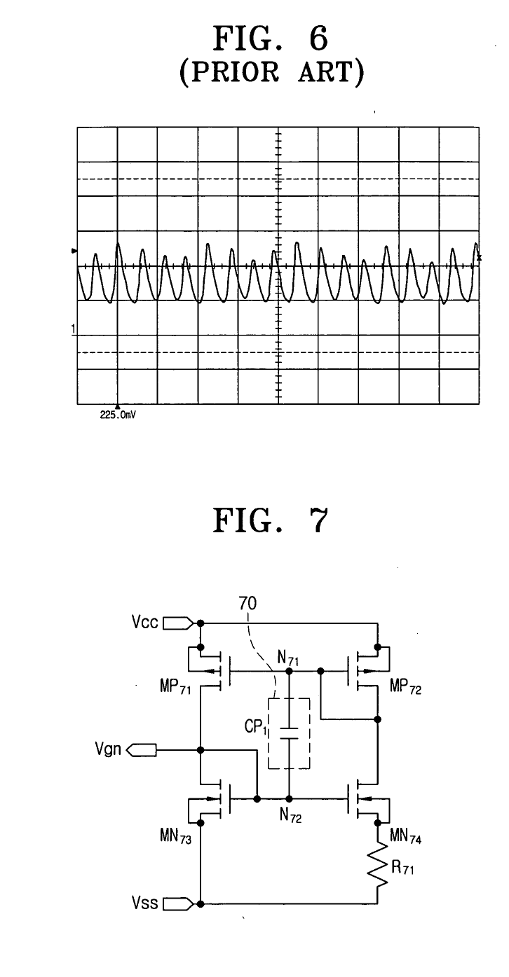

FIG. 7 is a view for showing a bias circuit having a start-up circuit according to an embodiment of the present invention. The bias circuit having a present start-up circuit includes a bias circuit having PMOS transistors MP₇₁ and MP₇₂, NMOS transistors MN₇₃ and MN₇₄, and a resistor R₇₁, and a start-up circuit 70 having a capacitor CP₁.

The gate of the PMOS transistor MP₇₁ and the gate and drain of the PMOS transistor MP₇₂ are connected in common, and their sources are connected to a power source voltage Vcc respectively, to thereby construct a current mirror circuit. The drains of the PMOS transistors MP₇₁ and MP₇₂ are connected to the drains of the NMOS transistors MN₇₃ and MN₇₄, respectively.

The gate and drain of the NMOS transistor MN₇₃ are connected in common to the gate of the NMOS transistor MP₇₄ to form an output node, and an output voltage Vgn is outputted through the output node. The sources of the NMOS transistors MN₇₃ and MN₇₄ are connected to the ground Vss.

The capacitor CP₁ is connected between the output node and a common node to which the gates of the PMOS transistors MP₇₁ and MP₇₂ constructing the current mirror are connected in common, and plays roles of performing an initial driving of the bias circuit and a frequency compensation.

In such a circuit configuration, a voltage of the node N₇₁ before an initial drive voltage is applied can be expressed in Equation 5 as follows.

V_{N71}<V_{THn} [Equation 5]

where, V_{TH} denotes a threshold voltage of the MOS transistor.

Since the voltage of the node N₇₁ is smaller than V_{THn}, the PMOS transistors MP₇₁ and MP₇₂ have a turn-off state. In such a state, NMOS transistors MN₇₃ and MN₇₄ have the turn-off state at the initial time when the power source voltage changes from 0 up to Vcc since its application thereof, so the voltage of the node N₇₁ increases in proportion to the power source voltage.

Since the nodes N₇₁ and N₇₂ are connected to the capacitor CP₁, a voltage of the node N₇₁ increases as the voltage of the node N₇₂ increases. At this time, the voltage, Vgn, of the node N₇₁ continues to increase, and, if a gate voltage of the NMOS transistor MN₇₃ becomes higher than the V_{THn}, the NMOS transistor MN₇₃ becomes turned-on. Accordingly, consecutively, the NMOS transistor MN₇₄ is turned on, and all the PMOS transistors MP₇₁ and MP₇₂ are turned on, so that a circuit for generating a reference voltage enters a normal operation state.

If the power source voltage becomes completely transient up to the voltage Vcc so as to have a state, the voltages of the nodes N₇₁ and N₇₂ form stable bias voltages. At this time, since the capacitor CP₁ is in the open-circuited state with respect to dc currents, no power consumption occurs.

Further, as described above, since such a reference voltage generation circuit has a positive feedback loop formed, the capacitor CP₁ carries out the start-up function together with a function of frequency compensation circuit, so as to play a role of eliminating the possibility of oscillating the reference voltage generation circuit.

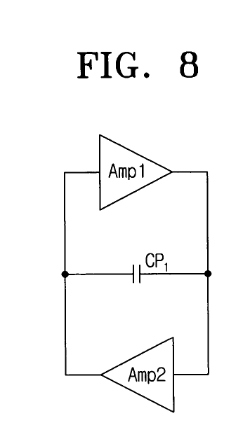

FIG. 8 is a view for showing an equivalent circuit of the circuit of FIG. 7. As shown in FIG. 8, the circuit of FIG. 7 can be redrawn to an equivalent circuit with two amplifiers Amp1 and Amp2 of feedback structure and the capacitor CP₁. At this time, the frequency compensation is implemented by the capacitor CP₁, so the oscillation possibility as in the conventional circuit is eliminated.

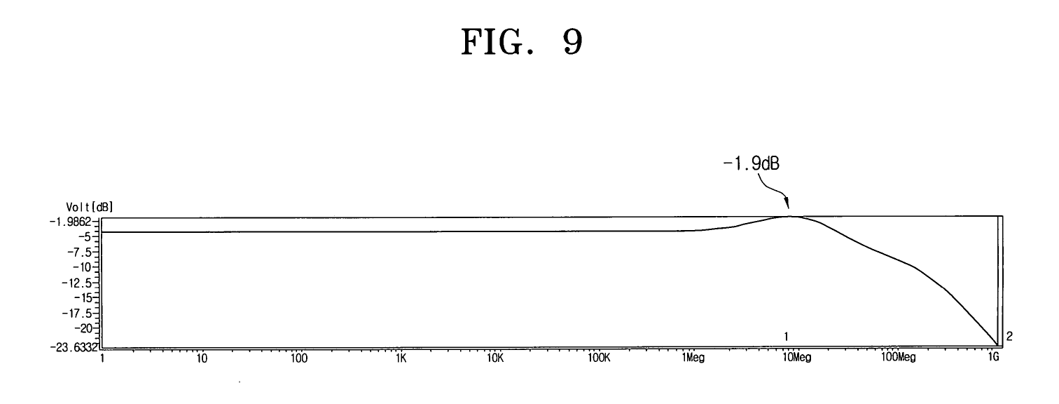

FIG. 9 is a simulation graph for showing frequency characteristics of a bias circuit having a start-up circuit according to a first embodiment of the present invention. In the graph, the x-axis indicates frequencies and the y-axis shows gains corresponding to the frequencies of the x-axis. As shown in the graph, the frequency compensation is carried out by the capacitor CP₁ so that the gains do not become larger than 0dB even in a high frequency range.

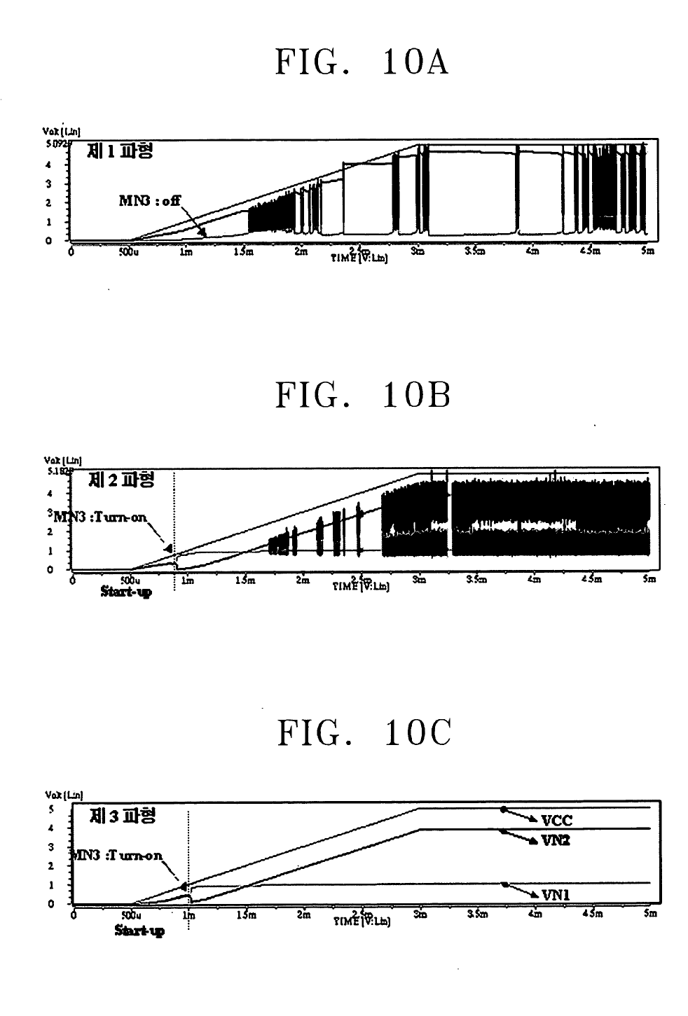

FIG. 10A to FIG. 10C are views for showing output waveforms for a bias circuit having a conventional start-up circuit and a bias circuit having a start-up circuit according to present invention.

FIG. 10A shows an output waveform of a bias circuit having no start-up function, FIG. 10B shows an output waveform of a bias circuit having a conventional start-up circuit, and FIG. 10C shows an output waveform having a start-up circuit according to the present invention.

As shown in the graphs, FIG. 10A shows that a desired bias voltage is not outputted since no start-up function is provided. Further, In FIG. 10B, a desired bias voltage can be outputted with a start-up function provided, but oscillations occur in a high frequency range. However, in FIG. 10C, it can be seen that a stable bias voltage is outputted, but any oscillation phenomenon does not exist with frequencies compensated.

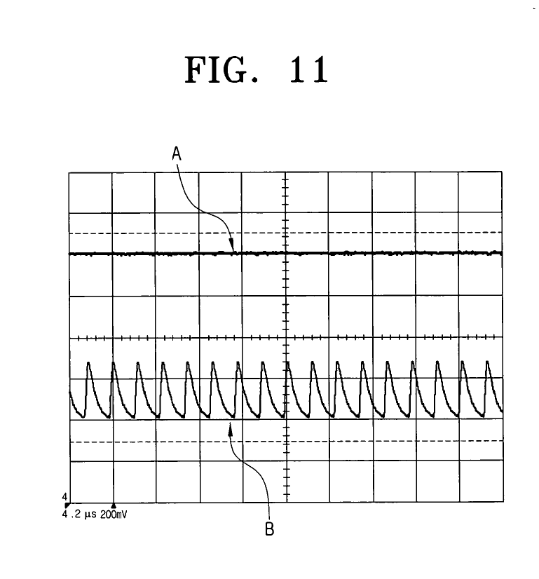

FIG. 11 shows a voltage waveform outputted from a bias circuit having a start-up circuit according to the present invention, and a voltage waveform outputted from a bias circuit having a conventional start-up circuit. In FIG. 11, a waveform A denotes a voltage waveform outputted from the present invention, and a waveform B denotes a voltage waveform of a conventional circuit. As shown in FIG. 11, it can be seen that the output voltage of the bias circuit having the start-up circuit according to the present invention is more stable.

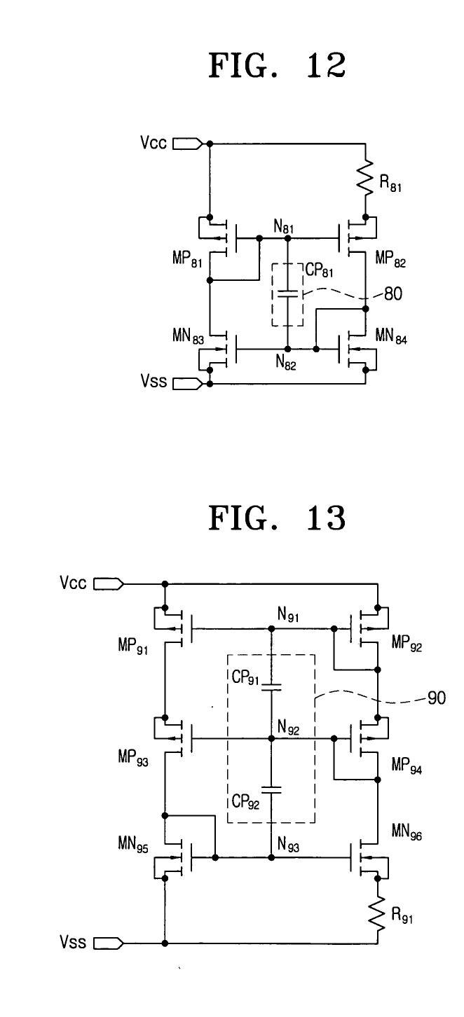

FIG. 12 to FIG. 14 are views for showing diverse circuits formed based on principles according to the present invention.

In FIG. 12, compared to the circuit of FIG. 7, a resistor R₈₁ is connected between the source of a PMOS transistor MP₈₂ and the power source voltage, and the entire operations of the circuit with the operations of the current mirror circuit are the same as those of FIG. 7.

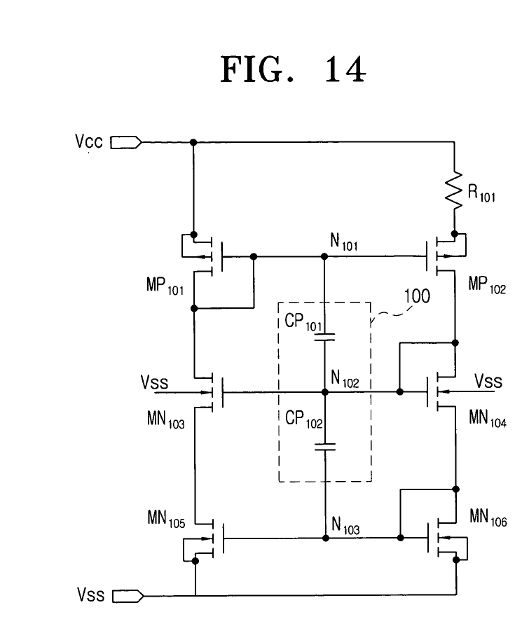

FIG. 13 and FIG. 14 show cascade circuits having a current mirror circuit formed in a double stage. A current source circuit has a large small-signal output resistance value so that a current of nearly constant value can be outputted regardless of output voltage value variations. Accordingly, a current source circuit of cascode form is used in order to increase a small-signal output resistance value.

The operation principle of such a circuit, as described in FIG. 7, is to cause capacitors CP₈₁, CP₉₁, CP₉₂, CP₁₀₁, and CP₁₀₂ used in start-up circuits 80, 90, and 100 to activate the bias circuit upon an initial application of a power source voltage, carrying out a function of frequency compensation.

As aforementioned, the present invention provides a bias circuit having a start-up circuit, which eliminates noise derived from a power source voltage, prevents power consumption due to a start-up circuit, and eliminates the oscillation possibility with stability improved in a high frequency range.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A bias circuit having a start-up circuit, comprising:
a bias circuit part using a current mirror circuit, and for generating a constant bias voltage to an output node from a power source voltage as applied, and
a start-up circuit part having a capacitor connected between the output node and a common node of in common connecting gates of MOS transistors constructing the current mirror circuit.

2. The bias circuit as claimed in claim 1, wherein the bias circuit part includes:
a first PMOS transistor having a source thereof connected to the power source voltage;
a second PMOS transistor having a gate and a drain thereof connected to a gate of the first PMOS transistor to form the common node, and having a source thereof connected to the power source voltage;
a first NMOS transistor having a drain and a gate thereof connected to a drain of the first PMOS transistor to form the output node, and having a source thereof connected to a grounded power source;
a second NMOS transistor having a drain thereof connected to the drain of the second PMOS transistor, and having a gate thereof connected to the gate of the first NMOS transistor; and
a resistor connected between the source of the second NMOS transistor and the grounded power source.

3. A bias circuit having a start-up circuit, comprising:
a bias circuit part using a cascode current mirror circuit of a double-stage current mirror circuit, and for generating a constant bias voltage to an output node from an applied power source voltage; and
a start-up circuit part for actuating the bias circuit part upon an initial application of the power source voltage, the start-up circuit part including:
a first capacitor connected between a first common node connecting in common gates of first MOS transistors constructing a first single-stage current mirror circuit of the cascode current mirror circuit and a second common node connecting in common gates of second MOS transistors constructing a second single-stage current mirror circuit; and
a second capacitor connected between the second common node and the output node.
